(19) United States
(12) Patent Application Publication
(10) Pub. No.: US 2007/0140563 A1
(43) Pub. Date: Jun. 21, 2007

(54) PRINT INSPECTING APPARATUS

(75) Inventors: Keisaku KANO, Gunma (JP); Shoichi SHIMAMURA, Tokyo (JP); Kei MATSUEDA, Chiba (JP); Mineo KUBOTA, Yamanashi (JP); Hiromitsu TAMURA, Yamanashi (JP); Tsukasa KONDO, Yamanashi (JP)

Correspondence Address: ROBERTS, MLOTKOWSKI & HOBBES, P. O. BOX 10064, MCLEAN, VA, 22102-8064, US

(73) Assignees: GLORY LTD., Hyogo (JP); NISCA CORPORATION, Yamanashi (JP)

(21) Appl. No.: 11/609,252

(22) Filed: Dec. 11, 2006

(30) Foreign Application Priority Data
Dec. 19, 2005 (JP) 2005-364573

(51) Int. Cl. G06K 9/46

(52) U.S. Cl. 382/190

(57) ABSTRACT

A print inspecting apparatus which can perform print inspection flexibly at high precision at high speed without requiring a character recognizing processing is provided. The print inspecting apparatus 1 has a main unit 10 which reads images on a continuous business form conveyed in one direction, and a processing unit 30 which computes feature amounts from character information of characters which can be printed on a form by a system printer 70 and resolution information of the system printer 70, which are preliminarily inputted from a print server 60 to a correspondence dictionary between feature amounts and characters in advance, clips a character image from an image read by the main unit 10 to compute a feature amount of the clipped character, and utilizes correct solution information regarding a character string printed on the form by the printer 70, which is inputted from the print server 60 in advance, to determines a character to be inspected has been correctly printed on the form by the printer 70 when the feature amount of a clipped character is equal to or more than a determination reference value to the feature amount of the character whose correspondence relationship has been defined in the correspondence dictionary.

### FIELD OF THE INVENTION

The present invention relates to a print inspecting apparatus, and in particular to a print inspecting apparatus which inspects a character printed on a form or sheet printed by a printer.

### DESCRIPTION OF THE RELATED ART

For example, account sheets or debit notes monthly issued by a banking facility or the like are sent or mailed to respective customers after characters, numerals, and/or symbols (hereinafter, simply called “characters”) are printed on predetermined forms such as a fan-folded paper by a printing apparatus or a printer, respective forms are cut to individual forms by a post-processing apparatus, individual forms are folded as necessary, and they are automatically enclosed in envelopes by an inserting apparatus. Among them, when there are many account sheets to be issued or the like, a system printer which allows fast printing at high precision is used.

However, even if a high precision printer such as system printer is used, print defect due to printer failure, paper quality, print environment or the like, such as irregularities of characters, density differences (character thinning, blur, character thickening, or character collapse), character omission, or character skew occurs.

Therefore, technologies such as an inspecting apparatus for inspecting whether or not a dot in a print pattern printed by a printer meets a predetermined reference (for example, see JP-B-07-82542), a printer apparatus which performs template-matching or a bitmap matching between input image data and image data on a printed matter (for example, see Japanese Patent No. 2994257 or JP-A-2001-96872), a printer apparatus which performs comparison between a bitmap font generated from a character code in a character generator and a bitmap on a printed matter for determination (for example, see JP-A-2003-305927), and a print inspecting apparatus which divides a reference image of a whole printed matter inputted and an image of the whole printed matter read into pieces of the former image and pieces of the latter image and performs comparison between the former and the latter (for example, see JP-A-2000-172844) have been disclosed. As a technique for recognizing a hand-written character, a pattern recognizing apparatus which prepares a recognition dictionary utilizing a secondary identification function introduced from the Bays decision rule considering a rival category has been also disclosed (for example, see JP-A-2002-150221).

These conventional techniques can be roughly classified to two kinds of techniques of an image collating technique which collates image data used for printing and image data read from a printed matter with each other and a recognition collating technique which reads a printed matter to perform OCR processing thereon and collates a result obtained by converting recognized character to character data based upon character recognition.

In the above-described image collating technique, however, there is a superiority regarding the fact that collation of picture or the like can be performed, but since the number of mismatching pixels between images is counted so that determination about identity of images is made, when a character collation with high precision is performed, there is such complexity that pixel data which constitutes correct solutions at a collating time must be prepared corresponding to an object amount to be collated due to a constitution that image data is developed to respective pixels and presence/absence of image data is collated for each pixel, which is different form a human character recognition, so that such a problem arises that a range for identity determination at a collating time is reduced. On the other hand, in the recognition collating technique, since a complicated character recognizing processing using a recognition function or the like is required, and determination about identity between character codes is made, a determination about whether or not a character(s) has (have) been correctly printed on a form (printed matter) by a printer is only made as OK or NG, which results in lack in flexibility of determination, and such a problem arises that much time is required for collating processing due to relatively complicated processing to be performed.

### SUMMARY OF THE INVENTION

In view of these circumstances, an object of the present invention is to provide a print inspecting apparatus which can perform print inspection flexibly at high speed and with high precision without performing character recognizing processing.

In order to solve the above problem, according to the present invention, there is provided a print inspecting apparatus which inspects a character printed on a form by a printer, comprising: a conveying unit which conveys the form in one direction; an image reading unit which reads an image on the form conveyed by the conveying unit; a dictionary preparing unit which, based upon preliminarily inputted character information including codes, fonts and font sizes of all characters which can be printed by the printer and preliminarily inputted resolution information of the printer, computes feature amounts of all the characters to prepare a dictionary defining correspondence relationship between the computed feature amounts and the all characters; a feature amount computing unit that clips an image of a character printed on the form from the image read by the image reading unit to compute a feature amount of the clipped character; and a print determining unit which utilizes preliminarily inputted correct solution information regarding a character string printed on the form by the printer as index to make determination about whether or not the feature amount of the character to be inspected which has computed in the feature amount computing unit is equal to or more than a determination reference value preliminarily set to the feature amount of the character whose correspondence relationship has been defined in the dictionary preparing unit to determines that the character to be inspected has been printed on the form correctly by the printer when the feature amount of the character to be inspected which has computed in the feature amount computing unit is equal to or more than the determination reference value

In the present invention, feature amounts of all characters which can be printed on a form by a printer are computed based upon the preliminarily inputted character information including the codes, the fonts, and the font sizes of all the characters which can be printed on a form by the printer and the preliminarily inputted resolution information about the printer and a dictionary defining a correspondence relationship between the computed feature amounts and all the characters is prepared by the dictionary preparing unit. Correct solution information about a character string printed on a form by the printer is preliminarily inputted in the print determining unit. Character information of respective characters constituting the character string printed on the form is included in the correct solution information. Inputting of the character information, the resolution information, and the correct solution information may be performed through a recording medium which can be read by the dictionary preparing unit or the print determining unit, or it may be performed from the printer or the computer controlling the printer online. The form is conveyed by the conveying unit in the one direction, an image on the form conveyed by the conveying unit is read by the image reading unit, an image of a character printed on the from is clipped from the image read by the image reading unit in the feature amount computing unit, a feature amount of the character clipped is computed, determination about whether or not the character amount of the character to be inspected which is computed by the character amount computing unit is equal to or more that the determination reference value preliminarily set to the feature amount of the character whose correspondence relationship with feature amount has been defined in the dictionary preparing unit (the character whose correspondence relationship with the feature amount has been defined according to the dictionary prepared by the dictionary preparing unit) is made utilizing preliminarily inputted correct solution information as index, and when determination that the feature amount of the character to be inspected is equal to or more than the determination reference value is made, determination that the character to be inspected has been printed on the form by the printer correctly is made by the print determining unit.

In the present invention, such a constitution may be adopted that the image reading unit reads images on the form conveyed by the conveying unit for each page and the feature amount computing unit clips the images of the characters printed on the form from the image read for each page by the image reading unit one character by one character. Such a constitution may be adopted that an inspection field setting unit for setting an inspection field in each page of the form is further provided in order to improve a processing rate, and images of characters printed on the form are clipped from an image of the inspection field in the image read by the image reading unit which is set by the inspection field setting unit one character by one character. At this time, it is preferable that the feature amount computing unit has a plurality of computers which can compute feature amounts of characters clipped from the image read by the image reading unit for each page in parallel.

Such a constitution may be adopted that the dictionary preparing unit produces an image of each character from the character information and the resolution information to divide the produced image into small regions and utilizes an image formation direction of each small region as an element of the feature amount and the feature amount computing unit divides the image of the character clipped to small regions and utilizes an image formation direction of each small region as an element of the feature amount. Considering an off-line processing, such a constitution may be adopted that a reserving unit which, when determination that the feature amount of the character computed by the feature amount computing unit is less than the determination reference value to the feature amount of the character whose correspondence with the feature amount has been defined by the dictionary preparing unit has been made by the print determining unit, reserves character information of a character to be inspected and the image of the character clipped by the feature amount computing unit as log data is further provided. On the other hand, such a constitution may be adopted that a display unit which, when determination that the feature amount of the character computed by the feature amount computing unit is less than the determination reference value to the feature amount of the character whose correspondence with the feature amount has been defined by the dictionary preparing unit has been made by the print determining unit, displays an image of a character to be inspected which has been clipped by the feature amount computing unit and an input unit for causing an operator to input a determination result of the operator about whether or not the character to be inspected which has been displayed on the display unit has been printed on the form correctly by the printer to the print inspecting apparatus are further provided, and a verifying unit which verifies the dictionary prepared by the dictionary preparing unit and a determination reference value setting unit which sets the determination reference value according to a verification result obtained by the verifying unit are further provided.

According to the present invention, since the dictionary where the correspondence relationship between characters and their feature amounts has been defined based upon the character information of all the characters which can be printed on the form by the printer and the resolution information of the printer is prepared in the dictionary preparing unit and the correspondence relationship between the characters and their characteristics is given to the dictionary considering the resolution of the printer, determination about whether or not the character has been correctly printed by the printer can be made in the print determining unit considering the characteristic of the printer. Since determination about whether or not the feature amount of the character computed by the feature amount computing unit is equal to or more than the determination reference value of the feature amount of the character whose correspondence with the feature amount has been defined in the dictionary preparing unit is made in the print determining unit utilizing the correct solution information as index and the feature amounts are collated by the print determining unit, it becomes unnecessary to perform a character recognizing processing. Since determination is made utilizing the determination reference value as a threshold, such an advantage can be obtained that determination about whether or not a character has been correctly printed can be made flexibly with high precision by setting the threshold properly.

### BRIEF DESCRIPTION OF THE DRAWINGS

FIG. 1 is an appearance perspective view of a print inspecting apparatus of an embodiment to which the present invention can be applied;

FIG. 2 is a schematic sectional view of a main unit of the print inspecting apparatus;

FIG. 3 is a block diagram illustratively showing functions of processing units in the print inspecting apparatus;

FIG. 4 is a block diagram showing a daisy-chain structure between the main unit and the processing unit;

FIG. 5 is an explanatory diagram showing a print example printed on a continuous strip by a system printer;

FIG. 6 is an explanatory diagram showing a data structure of inspection job data;

FIG. 7 is a flowchart of a processing routine which a microcomputer in the main unit executes in a print inspecting processing;

FIG. 8 is a flowchart of a processing routine which a CPU in an image processing unit executes in a print inspecting processing;

FIG. 9 is a flowchart of a processing routine which an inspecting terminal executes in a print inspecting processing; and

FIG. 10 is a flowchart of a processing routine which an inspecting server executes in a print inspecting processing.

### DETAILED DESCRIPTION OF THE PREFERRED EMBODIMENTS

An embodiment of a print inspecting apparatus according to the present invention will be explained below with reference to the drawings. Incidentally, in the embodiment, an example where a continuous strip printed by a printer is inspected offline (non-linkage with printing performed by a printer) will be explained.

(Constitution)

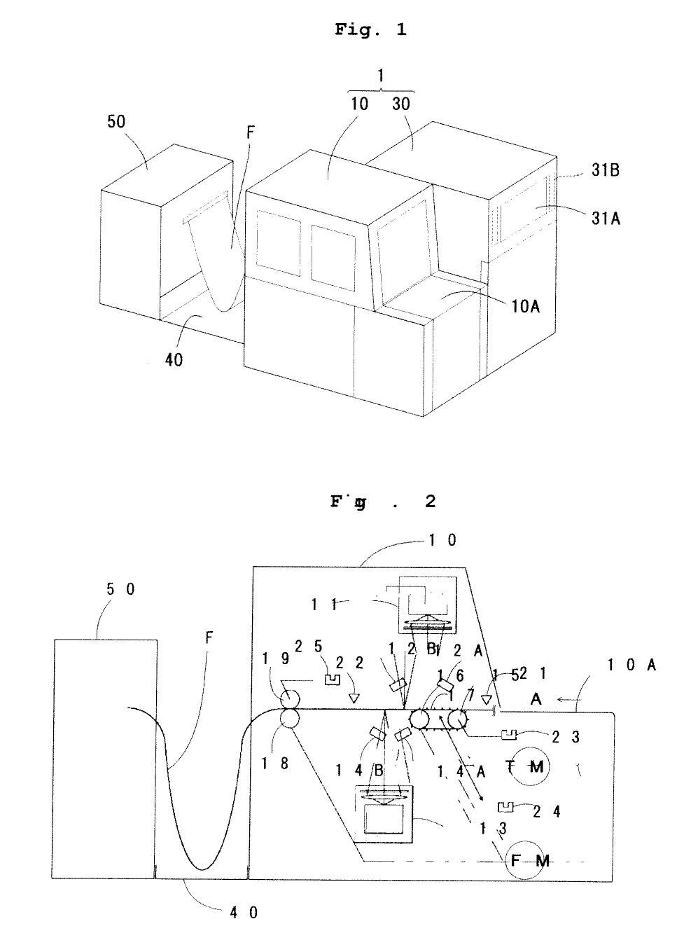

As shown in FIG. 1, a print inspecting apparatus 1 of the embodiment is provided with a main unit (reading unit) 10 which reads images printed on a continuous form strip F such as a fan-folded paper (folded print papers with feeding holes) by a printer, and a processing unit 30 which makes determination about whether or not characters, numerals, and symbols (hereinafter, called “character”) have been correctly printed on the continuous form strip F by the printer and serves as a dictionary preparing unit, a feature amount computing unit, a print determining unit, an inspection field setting unit, a verifying unit, and a determination reference value setting unit.

As shown in FIG. 2, the main unit 10 has two tractor belts 17 serving as the conveying unit which are formed with a plurality of projections engaged with feeding holes formed on both sides of the continuous form strip F to convey the continuous form strip F in one direction (in a direction of arrow A in FIG. 2) inside a casing having an approximately horizontal conveying face 10A. The tractor belts 17 are spanned between tractor rollers 15 and 16. Incidentally, the main unit 10 has a tractor width adjusting motor TM for adjusting a tractor width between the two tractor belts 17 in order to match with a width size of the continuous form strip F.

On the other hand, conveying and discharging rollers 18 and 19 serving as the conveying unit which coveys the continuous business form F in the one direction (in the direction of arrow A in FIG. 2) in cooperation with the tractor belts 17 and discharges the continuous form strip F outside the main unit 10 are disposed in the vicinity of a discharge port (not shown) of the casing. The tractor roller 16 and the conveying and discharging roller 18 are drive rollers, and are transmitted with rotational driving forces from a conveying motor FM (a portion of the conveying unit) composed of a stepping motor via a driving force transmission mechanism (not shown) composed of a plurality of gears. Incidentally, such a structure that the conveying and discharging roller 19 can be moved between two positions where it separates from the conveying and discharging roller 18 and contacts with the roller 18 is adopted for the conveying and discharging rollers 18 and 19 in order to allow setting of the continuous business form F in between the conveying and discharging rollers 18 and 19.

An upper face of the tractor belt 17 spanned between the tractor rollers 15 and 16 and a contacting point between the conveying and discharging rollers 18 and 19 are set to be approximately flush with each other. Therefore, the continuous business form F is guided into the casing of the main unit 10 approximately horizontally in a state that a back face thereof sliding-contacts with the conveying face 10A and the form F is pulled between the conveying and discharging rollers 18 and 19 and the tractor belt 17 with a constant force so that it is conveyed in its approximately horizontal state to be discharged outside the casing by the conveying and discharging rollers 18 and 19. Incidentally, in the embodiment, the maximum conveying speed of the continuous business form F is set to 1.5 m/s or so.

A surface line scan camera 11 serving as the image reading unit for reading an image printed on a surface of the continuous business form F is disposed above the tractor belt 17 on a downstream side thereof and a back face line scan camera 13 serving as the image reading unit for reading an image printed on a back face of the continuous business form F is disposed below the tractor belt 17 on a slightly downstream side of the surface line scan camera 11. The line scan cameras 11 and 13 are each composed of a dichroic filter, a lens, and a CCD line sensor in the casing.

White light LED arrays 12A, 12B, and 14A, 14B for illuminating reading positions of the line scan cameras 11 and 13 are disposed on both sides of the reading positions. Incidentally, rod lenses (not shown) for condensing white lights in a line shape to the reading positions are respectively disposed in the vicinity of the LED arrays 12A, 12B, and 14A, 14B.

An original set detecting sensor 21 for detecting whether or not a continuous business form F has been set in the main unit 10 which is disposed above the tractor belt 17 on an upstream side thereof, a remaining paper detecting sensor 22 for detecting whether or not the continuous business form F remains which is disposed between the tractor belt 17 and the conveying and discharging rollers 18 and 19, a rotary encoder 23 which is attached to a rotational shaft of the tractor roller 15 for detecting a conveyance amount of the tractor belt 17 to the continuous business form F, a tractor width home position detecting sensor 24 which is attached in the vicinity of a gear (not shown) for adjusting a tractor width between two tractor belts 17 for detecting a home position of the tractor width, and a jamming detecting sensor 25 which is attached to the rotational shaft of the conveying and discharging roller 19 for detecting jamming of the continuous business form F are disposed in the main unit 10, respectively.

The main unit 10 has a power source unit (not shown) which converts a commercial alternating current power source to a direct current power source which can drive/activate a drive unit or the like and a microcomputer (not shown) which performs operation control on the whole main unit 10. The microcomputer is connected with a sensor control unit for controlling the above-described sensors, an actuator control unit for controlling the motor drives, an image processing unit which has a CPU, for clipping an image corresponding to one page read by the line scan camera to conduct skew correction and for reading a barcode described later, and an interface for performing communication with the processing unit 30 via an external bus.

A plurality of opening doors for setting a continuous business form F and for maintenance and repair are provided in the casing of the main unit 10. A folding apparatus 50 for folding a continuous business form F and a loop stand 40 serving as a buffer for adjusting a folding rate of the folding apparatus 50 and a conveying speed of the continuous business form F of the main unit 10 are disposed on a downstream side of the main unit 10 in the order of the loop stand 40 and the folding apparatus 50.

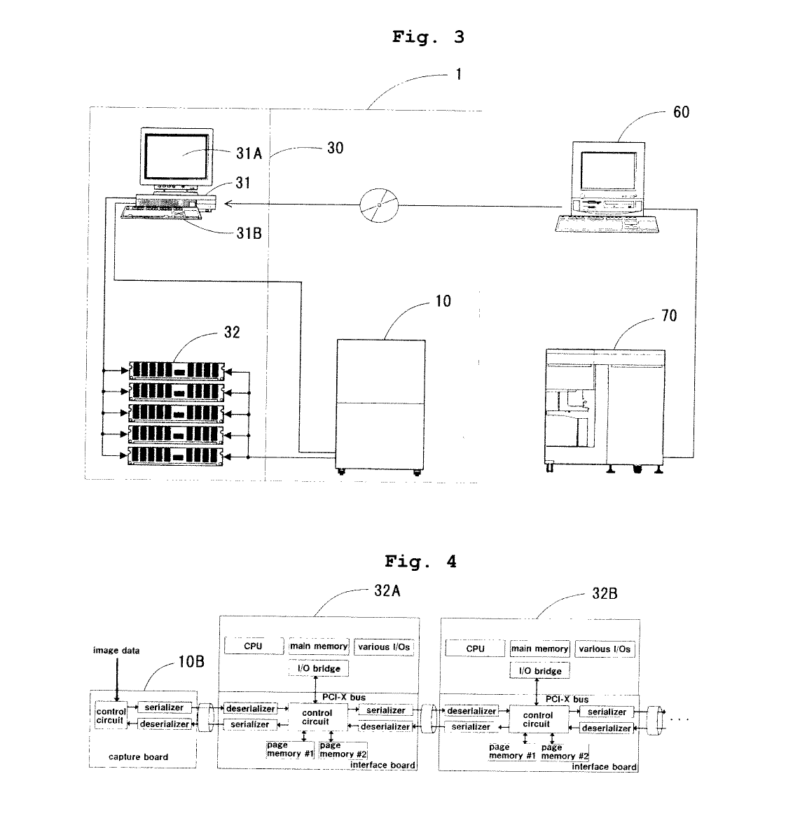

As shown in FIG. 1 and FIG. 3, the processing unit 30 is composed of an inspecting server 31 disposed inside the casing and inspecting terminals 32 (32A, 32B, 32C, 32D, and 32E) composed of a plurality of computers with the same specification. In other words, as shown in FIG. 1, when the processing unit 30 is considered mechanically, it is a lack accommodating the inspecting server 31 and the inspecting terminals 32 and when it is considered functionally, as shown in FIG. 3, it is a computer group for determining whether or not characters have been correctly printed on a continuous business form F by the printer. Incidentally, FIG. 3 is an equivalent block diagram of FIG. 1 mainly representing the function aspect for each computer.

As shown in FIG. 1, a display 31A (the display unit) of the inspecting server 31 is disposed on an upper portion of the processing unit 30, and a plurality of operation buttons (an operation buttons, corresponding to a keyboard of the inspecting server 31 shown in FIG. 3) are disposed on both sides of the display 31A. The inspecting terminals 32 are disposed in a lower portion of the inspecting server 31. As shown in FIG. 3, the inspecting server 31, the respective inspecting terminals 32, and the main unit 10 are connected to one another via communication lines.

As shown in FIG. 4, the interface of the main unit 10 has a capture board 10B having a control circuit, a serializer, and a deserializer. On the other hand, an interface board having a control circuit, a serializer, deserializer, and a page memory is disposed in each inspecting terminal 32. The capture board 10B of the main unit 10 and the interface board of each inspecting terminal 32 are connected to each other via a communication line in a daisy-chain manner. Therefore, the main unit 10 can transmit image data and the like to the inspecting terminal 32 put in a standby state.

(Continuous Business Form)

Next, the continuous business form F to be inspected in the print inspecting apparatus 1 of the embodiment will be explained. Incidentally, as shown in FIG. 3, the continuous business form F will be explained as one printed by the system printer 70 controlled by the print server 60 for simplification in explanation.

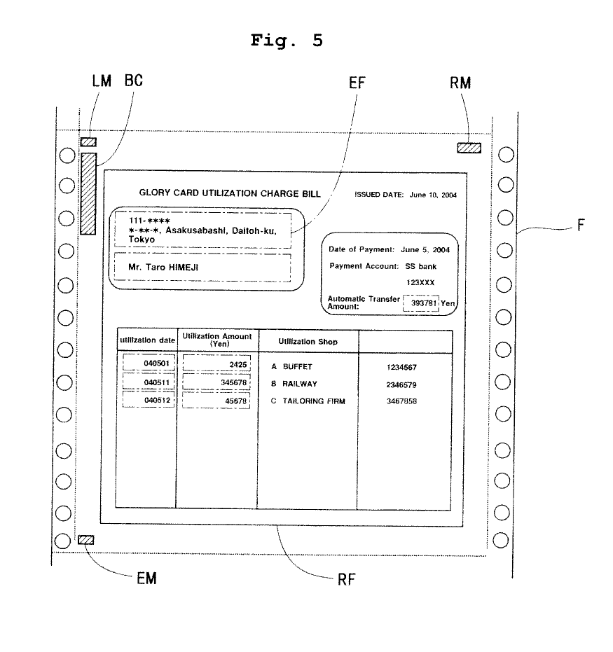

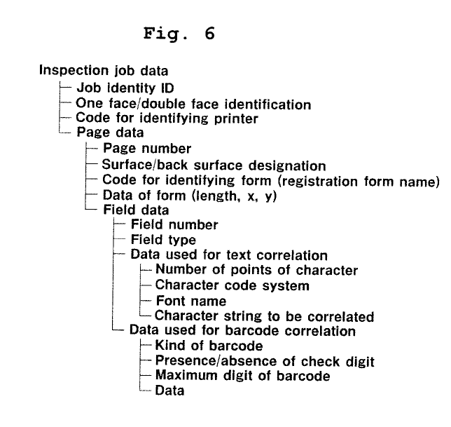

As shown in FIG. 5, each page of a continuous business form F is printed with a start left mark LM which represents start of each page and is arranged on a left side (on a leading side in a conveying direction and on a near side), a start right mark RM which represents start of each page and is arranged on a right side (on the leading side in the conveying direction and on a far side in FIG. 1) on the same height position as the start left mark RM, a barcode BC which is coded with print processing information (information for specifying a job and a page) to the continuous business form F for the system printer 70 and is disposed on a lower side of the start left mark LM, and an end mark EM which represents an end of each page and is arranged on a left side (a trailing side in the conveying direction and on the near side in FIG. 1) have been printed on each page of the continuous business form F such that images on the continuous business form F can be read for each page.

In the embodiment, the marks and barcodes are printed on the continuous business form F by the printer 70. The start left mark LM and the start right mark RM are printed at positions approximately symmetrically regarding in the conveying direction of the main unit 10 so as to have the approximately same shape in order to prevent erroneous recognition between the start left mark LM and the start right mark RM and another mark or the like even if the image processing unit in the main unit 10 recognizes some of a plurality of marks or the like. The start left mark LM is sufficiently larger in width than the end mark EM and the former is sufficiently shorter in length than the latter. The end mark EM is printed within a main scanning position the start left mark LM to the reading direction of the line scan cameras 11, 13. The barcode BC is printed in a sub-scanning direction of the line scan cameras 11, 13 within the main scanning direction of the start left mark LM. The width of the barcode BC is sufficiently shorter than the width of the start left mark LM.

FIG. 5 illustratively shows one example where the continuous business form F shown in FIG. 5 is used as an account sheet. Besides the above-described marks and barcodes, a character string constituting contents of the account sheet is printed on the continuous business form F by the printer 70. In the embodiment, characters in an inspection field EF shown by a one-dotted chain line in FIG. 5 are inspection target characters inspected by the print inspecting apparatus 1. In the embodiment, similar marks and barcodes are printed on a back face of the continuous business form F, and an inspection field EF can be set in a field different from a surface side.

(Operation)

Next, an operation of the print inspecting apparatus according to the embodiment will be explained in the order of the dictionary preparing processing, the form registering processing, and the print inspecting processing. The dictionary preparing processing and the form registering processing are performed before print inspection (processing) of the continuous business form F is performed by the print inspecting apparatus 1.

<Dictionary Preparing Processing>

The dictionary preparing processing is a processing which computes feature amounts of characters to be printed on a continuous business form F by the system printer 70 to prepare a dictionary defining correspondence relationship between the computed character amounts and characters (information).

Details are as follows:

First, character information including codes, fonts, and font sizes of all characters to be printed on a continuous business form F by the system printer 70 and resolution (DPI) information of the system printer 70 are written in a recording medium and they are inputted into an inspecting server 31 via the recording medium. In general, since fonts and font sizes of characters printed on the continuous business form F utilized as account sheets or debit notes are restrictive, amount of information recorded on the recording medium by the print server 60 is not so increased. Accordingly, the above-described “all characters to be printed” does not means all characters which can be printed by the system printer 70, but it means removal of characters with fonts and font sizes which are not printed on the continuous business form F. When the recording medium has an allowance, all characters which can be printed by the system printer 70 may be recorded on the recording medium.

The inspecting server 31 temporality stores character information and resolution information inputted in a hard disk and transmits character information about several tens characters of all characters constituting the character information together with resolution information to each inspecting terminal 32.

Each inspecting terminal 32 produces an image according to, for example, JPEG one character by one character from the character information corresponding to the several tens characters and the resolution information of the system printer 70 which has received the information. The resolution of the image is set to be approximately equal to the resolution of the system printer 70 which has received the information. Next, feature amounts are computed by dividing the produced image small regions of 5×5, computing character vectors about slopes of respective small region in an image forming direction when 8 directions (45 degrees) are defined as reference vectors are computed, and multiplying weight coefficients by the respective character vectors. Incidentally, when the image is divided into the small regions of 5×5 and the reference vectors in the 8 directions are used, 200 characteristic spaces are formed for each one character, so that a characteristic vector (feature vector) of a small region constituting a character has a larger weight coefficient when the small region is positioned nearer an outer side of the character. Each inspecting terminal 32 calculates feature amounts of the several tens characters and transmits characteristic information corresponding to the received several tens characters, and image data and feature amounts for these characters to the inspecting server 31.

The inspecting server 31 uses the character information as index to define a correspondence relationship between the characters which can be printed by the system printer 70, and received feature amount and image data (prepare a portion of a dictionary defining a correspondence relationship among character information, feature amounts, and image data). Next, determination is made about whether or not a correspondence relationship of all characters constituting character information inputted via the recording medium has been defined (a dictionary for all characters has been prepared). When determination is negative, character information corresponding to further several tens is transmitted to an inspecting terminal 32 put in a standby state (which has transmitted feature amounts and the like to the inspecting server 31) in order to prepare the remaining portion of the dictionary. When determination is affirmative, each inspecting terminal 32 is caused to invalidate the feature amounts in the dictionary which has been prepared.

That is, the inspecting server 31 transmits the characteristic information and the feature amounts corresponding to several tens characters and the resolution lower than that of the above-described system printer 70 as resolution information to each inspecting terminal 32. Each inspecting terminal 32 produces an image one character by one character from the resolution information and the character information corresponding to several tens characters, divides the produced image into the above-described predetermined small regions to compute characteristic vectors about slopes of respective small regions in the image forming direction when eight directions are defined as reference vectors, and computes feature amounts obtained by multiplying the respective characteristic vectors by weight coefficients. Next, determination is made about whether or not the computed feature amount is equal to or more than an invalidation reference value preliminarily set to the received feature amount. When determination is affirmative, information indicating that the feature amount of a character to be invalidated is proper is added to the character information. When the determination is negative, information indicating that the feature amount of a character to be invalidated is improper is added to the character information. When a processing to several tens characters has been terminated, character information is transmitted to the inspecting server 31.

The inspecting server 31 determines whether or not it has received character information about all characters in the prepared dictionary. When determination is negative, the inspecting server 31 further transmits the characteristic information and the feature amounts corresponding to several tens characters and the resolution lower than that of the system printer 70 to an inspecting terminal 32 put in a standby state. When the determination is affirmative, the inspecting server 31 refers to information added to each character information to determine whether or not a character whose feature amount has been determined to be improper is present. When determination that the character whose feature amount has been determined to be improper is not present is made, the inspecting server 31 gives a dictionary name to the prepared dictionary (defining a correspondence relationship among character information, character amounts, and image data) to reserve contents of the prepared dictionary in a hard disk and transmit information about the dictionary and the dictionary name except for the correspondence relationship between the character information and the image data in the prepared dictionary, thereby terminating the dictionary preparing processing. When determination that the character whose feature amount has been determined to be improper is present is made, the inspecting server 31 causes the inspecting terminal 32 to change (lower) the validation reference value and continue this step until the feature amounts of all the characters in the prepared dictionary is determined to be proper, sets (the changed) validation reference value as a determination reference value described later (changes a default value of a determination reference value preliminarily set as accompanying information for the dictionary) to give a dictionary name to the prepared dictionary to reserve contents of the prepared dictionary in the hard disk and transmits information of the dictionary and the dictionary name except for information about a correspondence relationship between the character information and the image data in the prepared dictionary, thereby terminating the dictionary preparing processing. Each inspecting terminal 32 reserves the information of the received dictionary and the dictionary name in its hard disk.

<Form Registration Processing>

Next, the form registration processing will be explained. The form registration processing is a processing for setting the inspection field EF of the above-described continuous business form F, and details thereof are as follows:

The inspecting server 31 acquires image data corresponding to one page of a continuous business form F read by the main unit 10 via the inspecting terminal 32. Next, the inspecting server 31 clips an image including a region which can be inspected based upon the start left mark LM (or the start right mark RM) and the end mark EM of the image of the acquired image data to perform magnification correction and display the clipped image on the display 31A to wait for designation of the inspection field EF performed by an operator. The operator sequentially designates inspection field EF through an operation button 31B (or an external computer logged in the inspecting server 31) so that the inspecting server 31 acquires position information of the inspection fields EF.

The inspecting server 31 determines whether or not an operation button indicating the fact that designation of the inspection field EF is terminated is pushed down (or a command for terminating the designation has been received from the external computer). When determination is negative, the inspecting server 31 waits ready because the inspection field EF may be designated continuously. When the determination is affirmative, the inspecting server 31 gives a registration form name to the continuous business form F designated with the inspection field EF, stores (updates) image data of the clipped continuous business form F and the position information of the inspection field EF in the hard disk in relation with the registration form name and transmits the registration form name and the position information of the inspection field EF of the continuous business form F related to the registration form name to each inspecting terminal 32, thereby terminating the form registration processing. Each inspecting terminal 32 which has received the dictionary from the inspecting server 31 stores (or updates) the registration form name and the position information of the inspection field EF of the continuous business form in the hard disk associating them with each other.

Names which can be easily identified by an operator can be attached to the above-described dictionary name and the registration from name. For example, the operator can display the registration form name and the inspection field EF on the display 31A by operating the operation button 31B (logging in the inspecting server 31 from an external computer) to designate the name attached to the registration form name. FIG. 5 shows an example where nine inspection fields EF have been designated.

<Print Inspecting Processing>

Next, a print inspecting processing will be explained, prior to the print inspecting processing, the print server 60 outputs print data to the system printer 70 to cause the system printer 70 to print a character string desired by the operator on a continuous business form F and prepares inspection job data (correct solution information) based upon the print data outputted to the system printer 70 to output the same to a recording medium. The inspection job data includes the above-described character information. FIG. 6 shows one example of a data structure of the inspection job data. The inspection job data includes a job to the continuous business form F performed by the system printer 70 and print processing information for specifying each page or the above-described character information (job identity ID, field data) in addition to the information (code for identifying a printer, a code for identifying a form) for specifying the dictionary name and the registration form name.

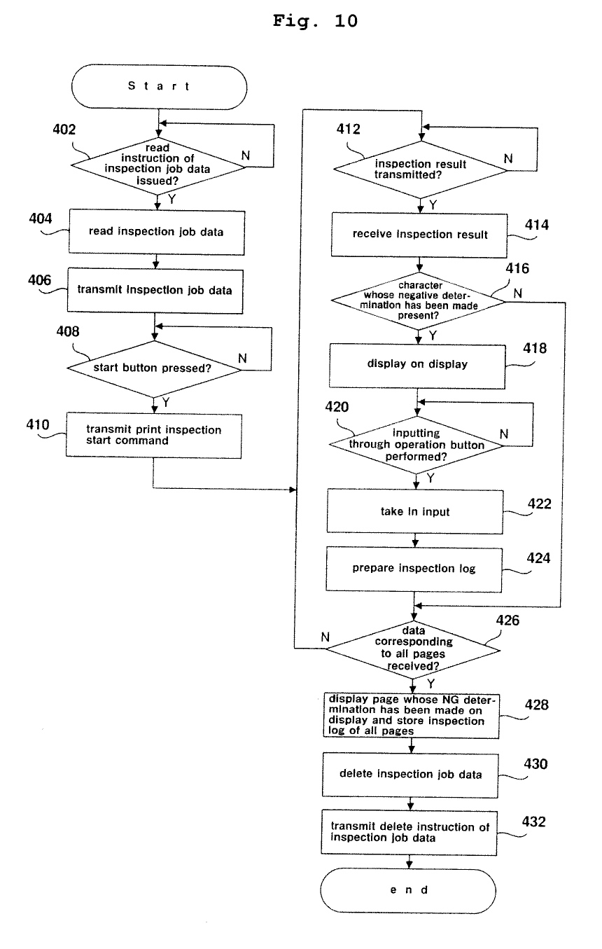

An operator operates the operation button 31B to cause the inspecting server 31 to read inspection data job recorded in the recording medium prepared by the print server 60 (steps 402 and 404 in FIG. 10). The inspecting server 31 reads the inspection job data to transmit the read inspection job data to each inspecting terminal (step 406). Thereby, preparation of the print inspecting processing at each inspecting terminal 32 is terminated (steps 302 and 304 in FIG. 9).

When the continuous business form F printed by the system printer 70 is set in the main unit 10 by an operator and a predetermined start button in the operation button 31b is pushed down by the operator (step 408 in FIG. 10), the print inspecting apparatus 1 starts the print inspection processing to transmit a print inspection start command to the microcomputer in the main unit 10 (step 410).

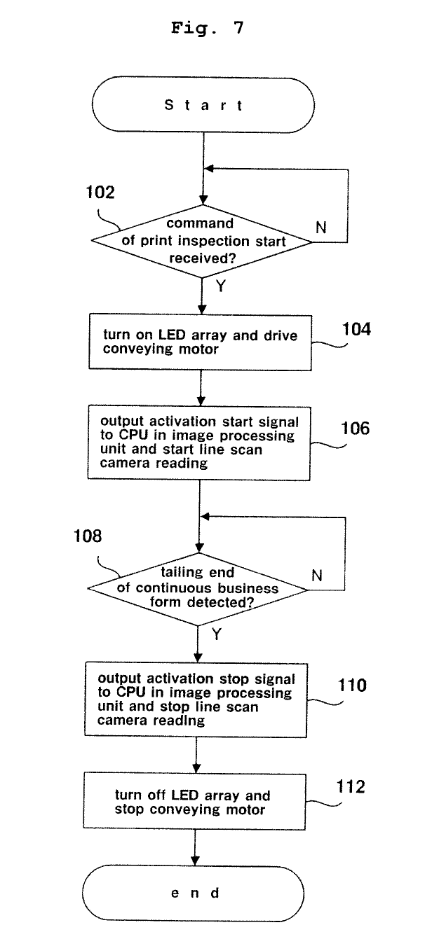

The microcomputer of the main unit 10 which has received the print inspection start command from the processing unit 30 (the inspection server 31) (step 102 in FIG. 7) lightens the LED arrays 12A, 12B, and 14A, 14B and drives the conveying motor FM via an actuator control unit (step 104). Thereby, the continuous business form F is conveyed at a constant speed in a direction of arrow A shown in FIG. 2, where the line scan cameras 11, 13 start image reading (step 106). The microcomputer outputs an activation start signal to the CPU in the image processing unit (step 106). The microcomputer refers to a signal for the sensor control unit to start monitoring of jam of a continuous business form F or the like. When the continuous business form F is discharged from the main unit 50 to a loop stand 40 in a certain length, an operator sets the discharged portion (a leading portion) of the continuous business form F in the folding apparatus 50. Thereafter, the main unit 50 performs the print inspection processing and the microcomputer monitors whether a remaining paper detecting sensor 22 has detected a tailing end of the continuous business form F. When the remaining paper detecting sensor 22 detects the trailing end of the continuous business form F (step 108), the microcomputer outputs an activation stop signal to the CPU of the image processing unit and stops reading performed by the line scan cameras 11, 13 (step 110) and turns OFF the LED arrays 12A, 12B, and 14A, 14B to stop drive of the conveying motor FM (step 112), thereby terminating the processing.

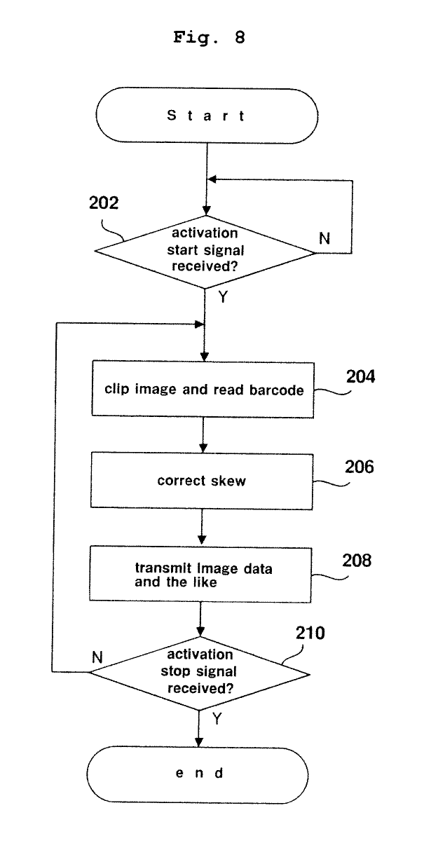

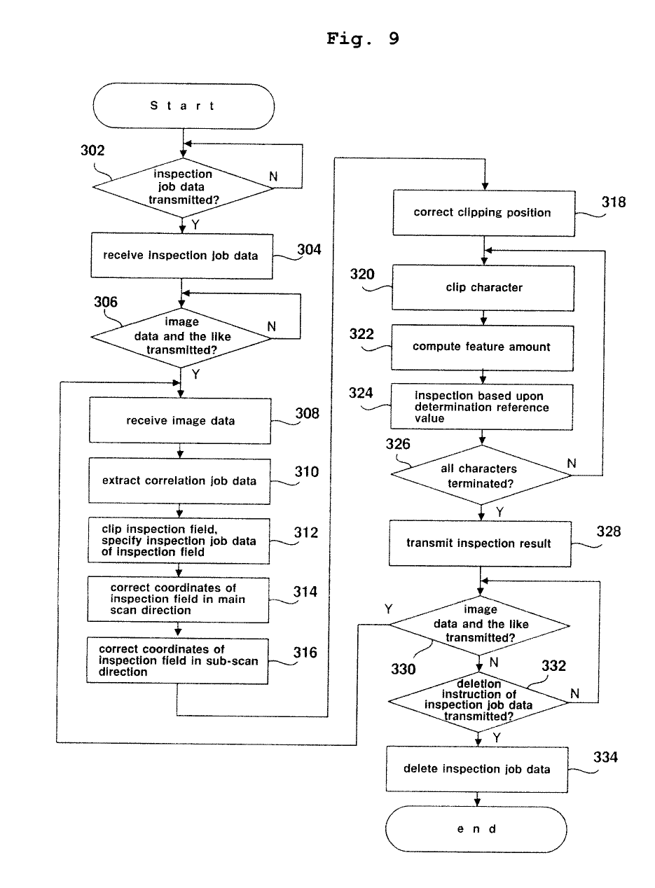

When the CPU of the image processing unit of the main unit 10 receives an activation start signal from the microcomputer of the main unit 10 (step 202 in FIG. 8), it clips an image corresponding to one page sectioned by the start left mark LM or the start right mark RM and the end mark EM (step 204). That is, the CPU clips an image from a time point when earlier one of the start right mark RM and the end mark EM has been detected at a reading position to the end mark EM as an image corresponding to one page. The CPU in the image processing unit reads the barcode BC printed after the start left mark LM in parallel with clipping of he image (step 204 for decoding the barcode BC and acquiring print processing information).

Next, the CPU of the image processing unit performs skew correction on the image corresponding to the clipped one page (step 208). That is, when the number of pixels Tx[pel] between the start left mark LM and the start right mark RM is counted, a deviation amount between the start right mark RM and the start left mark LM in the conveying direction is counted as a skew amount delta Ty [line], and image data of coordinates (x, y) is defined as V(x,y), skew correction is performed according to the following equation:
V(x,y)=q(x)·V(x,y+s(x)+r(x)·V(x,y+s(x)+1)
Where s(x)=int(x·deltaTy/Tx),r(x)=x·deltaTy/Tx−s(x), q(x)=1−r(x)

The CPU of the image processing unit counts the number of main scanning lines Ty[line] between the start left mark LM and the end mark EM and counts delta x when a deviation amount between the start left mark LM and the end mark EM is defined as delta x+Offset[pel]so as to correct the coordinates when an image of the inspection field EF is clipped at an inspection end. When terminates the skew correction, the CPU of the image processing unit sequentially transmits image data corresponding to one page whose skew has been corrected, the read barcode data (print processing information such as decoded print job or page), the number of pixels Tx between the start left mark LM and the start right mark RM, the number of main scanning line Ty between the start left mark LM and the end mark EM, and delta x when the deviation amount between the start left mark LM and the end mark EM is defined as delta x+Offset[pel] to an inspecting terminal 32 put in a standby state (step 208). The CPU of the image processing unit determines whether or not it has received an activation stop signal from the microcomputer of the main unit 10 (step 210, also see step 110 in FIG. 7). When determination is negative, the CPU returns back to step 204. When the determination is affirmative, the CPU terminates the processing.

Each inspecting terminal 32 recognizes its own processing part form the received barcode (print processing information) (steps 306, 308 in FIG. 9) to extract collation job data (correct solution information) of characters on the corresponding page from the already received inspection job data (steps 302, 304) (step 310). Each inspecting terminal 32 recognizes a registration form name from the inspection job data to acquire position information of the already-received inspection field EF from the registration form name, and clips an image of the inspection field EF from the image data corresponding to the received one page and specifies the inspection job data (correct solution information) of the inspection field EF (step 312).

Each inspecting terminal 32 causes the number of pixels Tx [pel] between the received start left mark LM and start right mark RM to correspond to the distance x mm in the inspection job data to obtain a magnification correction coefficient Ax in the main scanning direction from the optical resolution p[DPI], for example, as Ax=25.4·Tx/(p·x) and corrects the coordinates of the inspection field EF in the main scanning direction (step 314). For example, (the coordinate in the main scanning direction after correction)=Ax·(the coordinate of the inspection field EF in the main scanning direction instructed by the inspection job data) can be used for this correction.

Each inspecting terminal 31 causes the number of main scanning lines Ty[line] between the start left mark LM and the end mark EM and the corresponding distance y mm in the inspection job data to correspond to each other to obtain a magnification correction coefficient Ay in the sub-scanning direction from the optical resolution p[DPI], for example, as Ay=25.4·Ty/(p·y) and corrects the coordinates of the inspection field EF in the sub-scanning direction (step 316). For example, (the coordinate in the sub-scanning direction after correction)=Ay·(the coordinate of the inspection field EF in the sub-scanning direction instructed by the inspection job data) can be used for this correction.

Each inspecting terminal 31 corrects the main scanning direction of the clipping position of the inspection field EF based upon the deviation amount delta x when a deviation amount between the received start left mark LM and end mark EM is defined as delta x+Offset[pel] (step 318). Here, Offset represents a positional deviation amount in the main scanning direction due to a difference in shape between the start left mark LM and the end mark EM. Skew correction is performed by causing the number of main scanning lines Ty[line] between the start left mark LM and the end mark EM to correspond to the corresponding distance y mm in the inspection job data to obtain a magnification correction coefficient Ax′ in the main scanning direction from the optical resolution p[DPI], for example, as Ax′=delta x/Ty and correcting the coordinates of the inspection field EF according to the following equation to correct the coordinates of the inspection field EF to skew in the main scanning direction:
(coordinates in the main scanning after correction)=Ay·(the coordinate of the inspection field EF in the sub-scanning direction instructed by the inspection job data)

Next, each inspecting terminal 32 clips character images from an image in the inspection field EF one character by one character (step 320), divides the character image into the above-described predetermined small regions, computes character vectors of slopes of respective small region in the image forming direction, and computes feature amounts by multiplying the respective characteristic vectors by weight coefficients (step 322). Next, each inspecting terminal 32 utilizing collation job data (correct solution information) of the clipped character as index to determine whether or not the computed feature amount is equal to or more than the determination reference value received to the feature amount corresponding to the clipped character in the already-received dictionary (step 324). When determination is affirmative, it is determined that the character (the character to be inspected) clipped from the image in the inspection field EF has been correctly printed on the continuous business form F by the system printer 70.

Each inspecting terminal 32 collects determination results for each page (step 326) to transmit them to the inspecting server 31 as an inspection result (step 328). At this time, Regarding a character which has been subjected to negative determination (determination that the character has not been printed properly), each inspecting terminal 32 transmits attribute information regarding the character (a barcode, character information of the character in the collation job data) and image data of the image clipped from the inspection field EF about the character to the inspecting server 31. Thereafter, each inspecting terminal 32 determines whether or not image data about another page (see step 308 in FIG. 8) or the like is transmitted from the image processing unit (step 330 in FIG. 7) When determination is affirmative, each inspecting terminal 32 returns back to step 308. When the determination is negative, each inspecting terminal 32 determines whether or not an erase instruction of the inspection job data has been transmitted form the inspecting server 31 (step 332, also see step 432 in FIG. 10). When determination is negative, each inspecting terminal 32 returns back to step 330. When the determination is affirmative, each inspecting terminal 32 proceeds to step 334.

The inspecting server 31 which has received the inspection result (steps 412, 414 in FIG. 10) determines whether or not a character which has been subjected to negative determination is present (step 416). When determination is affirmative, regarding characters which have been determined as improper printing the inspecting server 31 sequentially displays both the image of the character extracted by referring the dictionary utilizing the character information included in the attribute information and the image of the character which has been clipped from the inspection field EF and has been transmitted from the inspecting terminal 32 on the display 31A (step 418) and it stands by until a predetermined button in the operation buttons 31B is pressed down such that an operator can make determination about OK or NG visually (step 420). When the operator pushes down the operation button, the inspecting server 31 produces the inspection result and the determination result of OK or NG visually made by the operator as inspection log of the corresponding page (steps 422, 424).

On the other hand, when the inspecting server 31 determines that no character which has been subjected to negative determination is present in the inspection result received from the inspecting terminal 32, it refers to page data in the inspection job data to stand by until it receives the inspection result about all the pages and performs a similar processing (step 426) to refer to inspection log for each page to display visual result of the operator and the page which has been determined as NG on the display 31A. The inspecting server 31 reserves the inspection log of all the pages (step 428), deletes the inspection job data (step 430), and transmits deletion instruction of the inspection job data to the each inspecting terminal 32 (step 432), thereby terminating the print inspection. When each inspecting terminal 32 receives the instruction (step 332), it deletes the inspection job data (step 334) to terminal the processing. Incidentally, the page which has been determined as NG can be printed again by the system printer 70 through reference to the inspection log or it may be corrected manually or by another means.

(Operation and the Like)

Next, an operation and the like of the print inspecting apparatus 1 according to the embodiment will be explained.

In the print inspecting apparatus according to the embodiment, a dictionary defining a correspondence relationship between characters which can be printed by the system printer 70 and feature amounts thereof is prepared by the processing unit 30 (the inspecting server 31 and the inspecting terminals) from character information of all characters which can be printed on a continuous business form F by the system printer 70. At this time, since the processing unit 30 prepares the dictionary considering the resolution information of the system printer 70, print characteristics of the system printer 70 are reflected on the dictionary. Therefore, determination about whether or not characters have been correctly printed by the system printer 70 can be determined considering the characteristics of the system printer 70.

In the print inspecting apparatus 1 according to the embodiment, since a dictionary defining a correspondence relationship between characters which can be printed and feature amounts thereof is prepared in advance, each character printed on a continuous business form F is clipped and a feature amount thereof is computed, and feature amounts of the clipped character and the character in the dictionary are collated as utilizing the collation job data (correct solution information). Since the feature amounts of the clipped character and the character in the dictionary are collated, a complicated character recognizing processing using a recognition function or the like is not required. Therefore, any complicated processing for character recognition is not required, so that error occurrence in character recognition can be prevented. Since the feature amounts of the clipped character and the character in the dictionary are compared with each other, such a problem can be solved that a determination range for identity at a collation time is reduced in the image correlating technique explained in the background art.

In the print inspecting apparatus 1 of the embodiment, since determination is made by the processing unit 30 that the feature amount is equal to or less more than the determination reference value, determination about whether or not characters have been correctly printed can be made flexibly and with high precision by changing the determination reference value according to the characteristics (resolution) of the system printer 70.

In the print inspecting apparatus 1 according to the embodiment, since marks printed on the continuous business form F are unique, when the image processing unit in the processing unit 30 recognizes a portion of a mark, erroneous recognition between the mark and another mark can be prevented. Since the image processing unit in the processing unit 30 performs skew correction, a positional precision when each inspecting terminal 32 clips an inspection field EF can be improved.

In the print inspecting apparatus 1 according to the embodiment, since the inspecting terminals 32 are composed of a plurality of computers, the inspecting server 31 transmits image read for each page to an inspecting terminal 32 put in standby state and performs feature amount computation and the like concurrently, and the inspecting terminal 32 makes determination about whether or not only characters in an inspection field EF set in the form registration processing has been correctly printed on a continuous business form F, the print inspection can be performed rapidly.

In the print inspecting apparatus 1 according to the embodiment, since the print inspection is performed in off-line manner and the dictionary preparing processing, the form registration processing, and the print inspecting processing can be performed for each plural printers (since these processings are not limited to a specific printer), high versatility can be secured.

In the embodiment, the example where characters printed on the continuous business form F by the system printer 70 in on-line manner are inspected has been explained. As explained in the background art, however, in such a case that a series of processings from printing on a continuous business form F to sealing of each form in an envelope are continuously performed, an on-line configuration can be adopted. In this case, the continuous business form F discharged from the system printer 70 maybe set in the main unit 10 from a loop stand having a buffering function, or the print server 60 and the processing unit 30 may be connected via a communication line.

In the embodiment, the example where images on a continuous business form F is read with a high-speed line sensor has been explained, but an area sensor can be used in order to increase a reading rate. In the embodiment, the example where both faces of a continuous business form F are read has been shown, but such a constitution may be adopted that only one face of a continuous business form F is read, of course.

In the embodiment, as shown in FIG. 6, the example where the inspection job data includes the code for identifying a printer or the code for identifying a form has been shown, but an operator may input the inspection job data except for these codes from the operation button 31B. In the embodiment, the example where skew processing is performed in the main unit 10 has been shown, but the skew processing may be performed by the inspecting terminal 32 for each page.

In the embodiment, the example where the determination reference value is changed according to the characteristics (resolution) of the system printer 70 has been explained, but the determination reference value may be changed according the characteristics of the continuous business form F. In the embodiment, the example where characters printed on a continuous business form are inspected has been shown, but the present invention is not limited to this example. For example, the present invention can be applied to a print inspecting apparatus which inspects characters printed on a single form continuously or intermittently, of course.

### INDUSTRIAL APPLICABILITY

As explained above, since the present invention provides a print inspecting apparatus which can perform print inspection flexibly at high precision at high speed without requiring a character recognizing processing, it contributes to manufacture and sale of a print inspecting apparatus and has high industrial applicability.

What is claimed is:

1. A print inspecting apparatus which inspects a character printed on a form by a printer, comprising:
a conveying unit which conveys the form in one direction;
an image reading unit which reads an image on the form conveyed by the conveying unit;
a dictionary preparing unit which, based upon preliminarily inputted character information including codes, fonts and font sizes of all characters which can be printed by the printer and preliminarily inputted resolution information of the printer, computes feature amounts of all the characters to prepare a dictionary defining correspondence relationship between the computed feature amounts and the all characters;
a feature amount computing unit that clips an image of a character printed on the form from the image read by the image reading unit to compute a feature amount of the clipped character; and
a print determining unit which utilizes preliminarily inputted correct solution information regarding a character string printed on the form by the printer as index to make determination about whether or not the feature amount of the character to be inspected which has computed in the feature amount computing unit is equal to or more than a determination reference value preliminarily set to the feature amount of the character whose correspondence relationship has been defined in the dictionary preparing unit to determine that the character to be inspected has been printed on the form correctly by the printer when the feature amount of the character to be inspected which has been computed in the feature amount computing unit is equal to or more than the determination reference value.

2. A print inspecting apparatus according to claim 1, wherein the image reading unit reads images on the form conveyed by the conveying unit for each page and the feature amount computing unit clips the images of the characters printed on the form from the image read for each page by the image reading unit one character by one character.

3. A print inspecting apparatus according to claim 1, further comprising an inspection field setting unit for setting an inspection field in each page of the form, wherein images of characters printed on the form are clipped from an image of the inspection field in the image read by the image reading unit which is set by the inspection field setting unit one character by one character.

4. A print inspecting apparatus according to claim 2, wherein the feature amount computing unit has a plurality of computers which can compute feature amounts of characters clipped from the image read by the image reading unit for each page in parallel.

5. A print inspecting apparatus according to claim 1, wherein the dictionary preparing unit produces an image of each character from the character information and the resolution information to divide the image produced into small regions and utilizes an image formation direction of each small region as an element of the feature amount and the feature amount computing unit divides the image of the character clipped to small regions and utilizes an image formation direction of each small region as an element of the feature amount.

6. A print inspecting apparatus according to claim 1, further comprising a reserving unit which, when determination that the feature amount of the character computed by the feature amount computing unit is less than the determination reference value of the feature amount of the character whose correspondence to the feature amount has been defined by the dictionary preparing unit has been made by the print determining unit, reserves character information of a character to be inspected and the image of the character clipped by the feature amount computing unit as log data.

7. A print inspecting apparatus according to claim 1, further comprising a display unit which, when determination that the feature amount of the character computed by the feature amount computing unit is less than the determination reference value of the feature amount of the character whose correspondence to the feature amount has been defined by the dictionary preparing unit has been made by the print determining unit, displays an image of a character to be inspected which has been clipped by the feature amount computing unit and an input unit for causing an operator to input a determination result of the operator about whether or not the character to be inspected which has been displayed on the display unit has been printed on the form correctly by the printer to the print inspecting apparatus.

8. A print inspecting apparatus according to claim 1, further comprising a verifying unit which verifies the dictionary prepared by the dictionary preparing unit and a determination reference value setting unit which sets the determination reference value according to a verification result obtained by the verifying unit.
